(19) United States
(12) Patent Application Publication
(10) Pub. No.: US 2007/0226528 A1
(43) Pub. Date: Sep. 27, 2007

(54) RESET CONTROL APPARATUS AND OPTICAL DISC APPARATUS

(76) Inventor: Toyokazu EGUCHI, Inagi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/683,678

(22) Filed: Mar. 8, 2007

(30) Foreign Application Priority Data
Mar. 9, 2006 (JP) 2006-064336

(51) Int. Cl. G06F 1/32

(52) U.S. Cl. 713/320

(57) ABSTRACT

An reset control apparatus includes a first circuit which operates on the basis of a first power supply specification, a second circuit which operates on the basis of a second power supply specification, a first reset signal output unit which supplies to the first circuit a first reset signal for resetting the first circuit on the basis of a first reset specification, a second reset signal output unit which supplies to the second circuit a second reset signal for resetting the second circuit on the basis of a second reset specification, and a power voltage unit which supplies a predetermined voltage to the first reset signal output unit and the second reset signal output unit.

### CROSS-REFERENCE TO RELATED APPLICATIONS

This application is based upon and claims the benefit of priority from prior Japanese Patent Application No. 2006-064336, filed Mar. 9, 2006, the entire contents of which are incorporated herein by reference.

### BACKGROUND OF THE INVENTION

1. Field of the Invention

The present invention relates to an reset control apparatus in which circuit blocks having different operation power supply voltages and power supply noise frequency responses are mixedly provided, and to an optical disc apparatus.

2. Description of the Related Art

In a general method of resetting a system, a power supply voltage is monitored, and the system is reset if the power supply voltage lowers to a predetermined threshold voltage.

Jpn. Pat. Appln. KOKAI Publication No. 9-319468 discloses a technique in which a line, which monitors a power supply voltage, is provided with a C-R integration circuit, and an erroneous reset operation is prevented when the power supply voltage is recovered from an instantaneous halt.

In the prior art, a single voltage threshold and a frequency response to a single voltage threshold are adopted. Thus, in a system having a plurality of operation power voltage specifications, there is such a problem that a circuit block with a worst lower-limit voltage is determined with respect to both DC/AC voltage thresholds.

### BRIEF SUMMARY OF THE INVENTION

According to an aspect of the invention, there is provided an reset control apparatus comprising: a first circuit block which operates on the basis of a first power supply specification; a second circuit block which operates on the basis of a second power supply specification; a first reset signal output unit which supplies to the first circuit block a first reset signal for resetting the first circuit block on the basis of a first reset specification; a second reset signal output unit which supplies to the second circuit block a second reset signal for resetting the second circuit block on the basis of a second reset specification; and a power voltage unit which supplies a predetermined voltage to the first reset signal output unit and the second reset signal output unit.

### BRIEF DESCRIPTION OF THE SEVERAL VIEWS OF THE DRAWING

FIG. 1 is a block diagram showing a reset circuit according to an embodiment of the present invention;

FIG. 2 is a graph showing a reset voltage and reset frequency band in the reset circuit shown in FIG. 1;

FIG. 3 is a block diagram showing an example of an electronic apparatus using the reset circuit shown in FIG. 1;

FIG. 4 is a block diagram showing an example of an optical disc apparatus using the reset circuit shown in FIG. 1; and

FIG. 5 is a block diagram showing an example of an electronic apparatus in a case where a plurality of outputs of reset units in the reset circuit shown in FIG. 1 are not wired-OR connected.

### DETAILED DESCRIPTION OF THE INVENTION

An embodiment of the present invention will now be described with reference to the accompanying drawings.

The embodiment is described referring to the drawings.

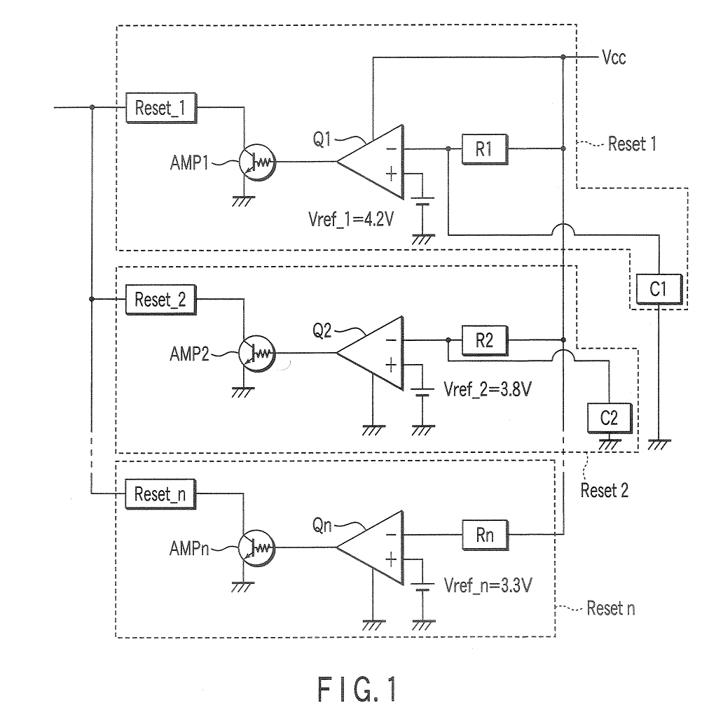

FIG. 1 is a block diagram showing the structure of an reset control apparatus according to the embodiment of the present invention. The reset control apparatus includes a first reset signal output unit Reset1, a second reset signal output unit Reset2, . . . , and an n-th reset signal output unit Reset-n.

A power supply voltage Vcc is supplied to an operational amplifier Q1 of the first reset signal output unit Reset1. A threshold voltage Vref_1 (e.g. 4.2V) is supplied to a (+) side of the operational amplifier Q1. One end of a resistor R1 is connected to a (−) side of the operational amplifier Q1. The power supply voltage Vcc is supplied to the other end of the resistor R1. One end of a capacitor C1 is connected to the above-mentioned one end of the resistor R1. The other end of the capacitor C1 is grounded.

An output of the operational amplifier Q1 is determined by a voltage which is obtained by integrating the threshold voltage Vref_1, which is supplied to the (+) side of the operational amplifier Q1, and the power supply voltage (monitor voltage) Vcc, which is applied to the (−) side of the operational amplifier Q1, by the resistor R1 and the capacitor C1. In the case where a noise frequency that is superimposed on the power supply voltage Vcc is 100 Hz (=1/(2π×C1×R1)) or more, the signal that is input to the (−) side of the operational amplifier Q1 is canceled by the integrating circuit that is composed of the resistor R1 and the capacitor C1. In the case where the voltage, which is obtained by integrating the power supply voltage Vcc by the first integrating circuit comprising the resistor R1 and the capacitor C1, is 4.2V (Vref_1) or less, or the noise frequency that is superimposed on the power supply voltage Vcc is 100 Hz or more (first reset specification), the output of the operational amplifier Q1 is at “Hi” level. The output from the operational amplifier Q1 is amplified by an amplifier AMP1, and an amplified signal is output as a reset signal Reset_1.

In the second reset signal output unit Reset2, the power supply voltage Vcc is supplied to an operational amplifier Q2. A threshold voltage Vref_2 (e.g. 3.8V) is supplied to a (+) side of the operational amplifier Q2. One end of a resistor R2 is connected to a (−) side of the operational amplifier Q2. The power supply voltage Vcc is supplied to the other end of the resistor R2. One end of a capacitor C2 is connected to the above-mentioned one end of the resistor R2. The other end of the capacitor C2 is grounded.

An output of the operational amplifier Q2 is determined by a voltage which is obtained by integrating the threshold voltage Vref_2, which is supplied to the (+) side of the operational amplifier Q2, and the power supply voltage (monitor voltage) Vcc, which is applied to the (−) side of the operational amplifier Q2, by a second integrating circuit comprising the resistor R2 and capacitor C2. In the case where a noise frequency that is superimposed on the power supply voltage Vcc is 1 kHz (=2/(2π×C2×R2)) or more, the signal that is input to the (−) side of the operational amplifier Q2 is canceled by the integrating circuit that is composed of the resistor R2 and capacitor C2. In the case where the voltage, which is obtained by integrating the power supply voltage Vcc by the resistor R2 and the capacitor C2, is 3.8V (Vref_2) or less, or the noise frequency that is superimposed on the power supply voltage Vcc is 1 kHz or more (second reset specification), the output of the operational amplifier Q2 is at “Hi” level. The output from the operational amplifier Q2 is amplified by an amplifier AMP2, and an amplified signal is output as a reset signal Reset_2.

In the n-th reset signal output unit Resetn, the power supply voltage Vcc is supplied to an operational amplifier Qn. A threshold voltage Vref_n (e.g. 3.3V) is supplied to a (+) side of the operational amplifier Qn. One end of a resistor Rn is connected to a (−) side of the operational amplifier Qn. The power supply voltage Vcc is supplied to the other end of the resistor Rn.

An output of the operational amplifier Qn is determined by a voltage which is obtained by subtracting a voltage drop due to the resistor Rn from the threshold voltage Vref_n, which is supplied to the (+) side of the operational amplifier Qn, and the power supply voltage (monitor voltage) Vcc, which is applied to the (−) side of the operational amplifier Qn. In the case where a voltage, which is obtained by subtracting a voltage drop due to the resistor Rn from the power supply voltage Vcc, is 3.3V (Vref_n) or less, the output of the operational amplifier Qn is at “Hi” level. The output from the operational amplifier Qn is amplified by an amplifier AMPn, and an amplified signal is output from the amplifier AMPn as a reset signal Reset_n.

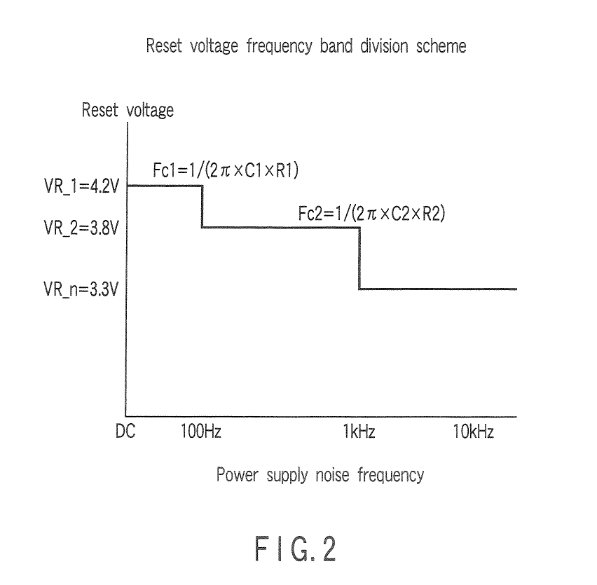

The outputs of the amplifiers AMP1 to AMPn are wired-OR connected. If the above-described circuit is used, threshold characteristics as shown in FIG. 2 are obtained. Specifically, the reset voltages are set at 4.2V, 3.8V and 3.3V, with boundaries being set at 100 Hz (=1/(2π×C1×R1)) and 1 kHz (=2/(2π×C2×R2)) of the noise frequencies that are superimposed on the power supply voltage Vcc.

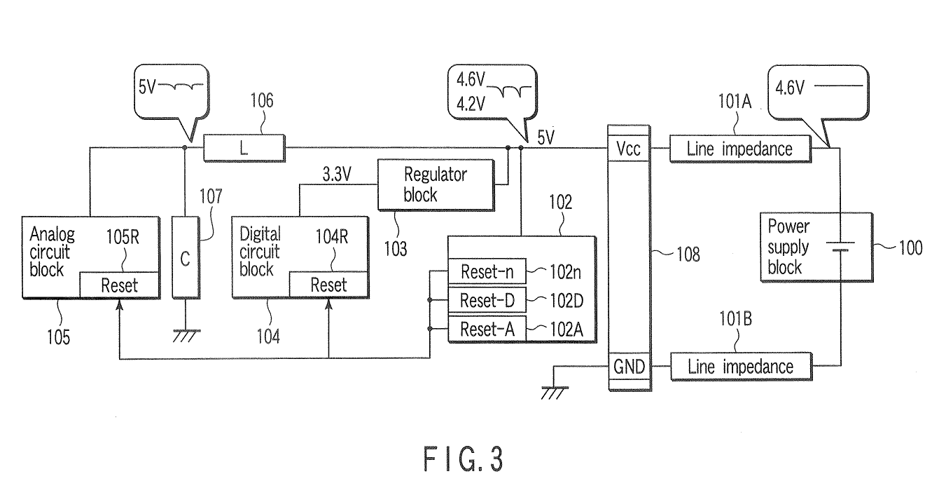

FIG. 3 shows a system using the above-described reset circuit.

A power supply voltage is supplied from a power supply block 100. A power supply voltage of 4.6V is supplied to a reset circuit 102. A power supply voltage of 4.6V is supplied to a regulator 103. The regulator 103 converts the power supply voltage of 4.6V to a constant voltage of 3.3V (first power supply specification), and an operation voltage of 3.3V is supplied to a digital circuit block 104. On the other hand, the power supply voltage of 4.6V is converted to a constant voltage of 5V by an inductance 106 and a capacitance 107 (second power supply specification), and the constant voltage of 5V is supplied to an analog circuit block 105.

The reset circuit 102 includes a digital reset unit 102D, an analog reset unit 102A and a reset unit 102n. The digital reset unit 102D outputs a reset signal in accordance with a reset voltage of the digital circuit block 104. An optimal reset voltage of the digital circuit block 104 is the regulator 103 output voltage (e.g. 3.3V) at which the digital circuit block 104 is rendered inoperable. The analog reset unit 102A outputs a reset signal in accordance with a reset voltage of the analog circuit block 105. An optimal reset voltage of the analog circuit block 105 is about 4.5V in the case of, for instance, an optical disc apparatus.

A reset unit 104R of the digital circuit block 104 and a reset unit 105R of the analog circuit block 105 receive the associated reset signals, and thereby the respective blocks 104 and 105 are reset.

As regards the operation by AC (noise variation frequency) of the analog circuit block 105, the degree of variation in performance is different in accordance with, for example,

(1) attenuation due to a noise filter inserted in the power supply line, and

### (2) CMRR (common mode rejection) performance of the analog circuit block 105.

In addition, the process of generation of noise voltage in the power supply line is associated with:

(1) noise voltage occurring in the supply power, and
(2) system-side consumption current variation and line impedances 101A and 101B.

Thus, the frequency response characteristics, which are necessary for the reset circuit of the analog block 105, are realized by the voltage thresholds shown in FIG. 2 and the CR filter time constant (=τ<product of resistance value and capacitance>).

According to the present system, even if there are a plurality of circuit blocks 104 and 105 having different operation power supply voltages and power supply noise frequency responses, it becomes possible to prepare a plurality of voltage thresholds and frequency responses which are optimal to a reset control of each of the circuit blocks. Thereby, it is possible to prevent a reset operation which may be needless for the other the circuit block.

Next, a description is given of an example in which the above-described circuit is applied to an optical disc apparatus.

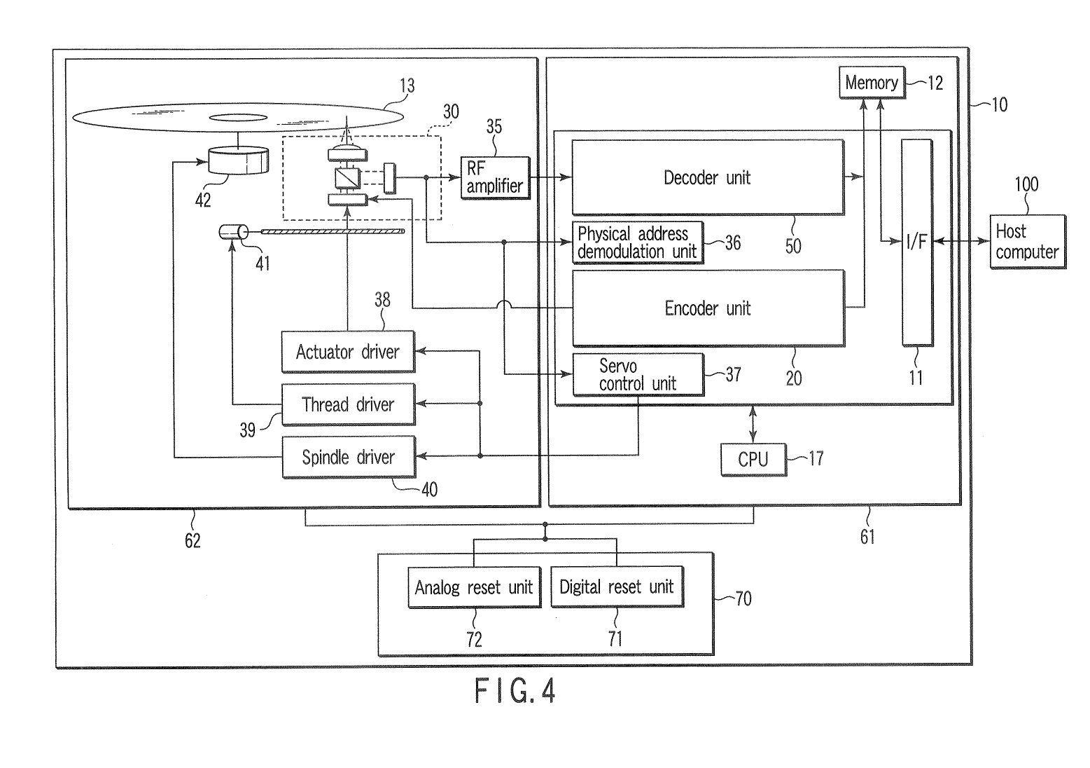

FIG. 4 is a block diagram showing the structure of the optical disc apparatus according to an embodiment of the invention.

In the optical disc apparatus 10, at a time of a recording mode, data, which is successively supplied from a host computer 100, is successively stored in a buffer memory 12 via an interface unit 11.

The data stored in the buffer memory 12 is successively delivered to an encoder unit 20 in units of a sector (2K-bytes). The encoder unit 20 adds an error correction code and sync data to the delivered data. The encoder unit 20 subjects the data to a predetermined modulation process in accordance with the format of an optical disc 13. The encoder unit 20 generates, from the modulated record data, record pulses which are suited to recording, and supplies the record pulses to an optical pickup head 30.

The optical pickup head 30 emits a light beam according to the record pulses. The light beam is radiated on the recording surface of the optical disc 13.

When the light beam is radiated, reflective light from the optical disc 13 is incident on the optical pickup head 30. The optical pickup head 30 converts the reflective light signal to an electric signal.

Based on the reflective light from the optical disc 13, the optical pickup head 30 generates servo error signals, such as a tracking error signal and a focus error signal, and a wobble signal and an RF signal. The servo error signals are supplied to a servo control unit 37, and the wobble signal is supplied to a physical address demodulation unit 36. The RF signal is delivered to a decoder unit 50 via an RF amplifier 35.

Based on the servo error signals supplied, the servo control unit 37 controls a spindle motor 42 via a spindle driver 40, thereby rotating the optical disc 13 at a predetermined speed. In addition, based on the servo error signals, the servo control unit 37 controls a thread motor 41 via a thread driver 39, thereby moving the optical pickup head 30 which moving a beam spot of the optical beam on the optical disc 13 (hereinafter referred to simply as “beam spot”) in a radial direction of the optical disc 13 along data tracks (pregrooves or lands) formed on the recording surface of the optical disc 13. Further, based on the servo error signals, the servo control unit 37 controls an actuator of the optical pickup head 30 via an actuator driver 38, thereby executing a tracking control and a focus control.

On the other hand, the physical address demodulation unit 36 subjects the wobble signal to a decoding process, thereby detecting an absolute address of the beam spot on the optical disc 13 at that time, and sending the absolute address to a CPU (Central Processing Unit) 17 as an address information signal.

Each time the absolute address on the optical disc 13, which is obtained by the above-described decoding process, varies (that is, each time the sector that is scanned by the beam spot on the optical disk 13 varies), the physical address demodulation unit 36 sends a sink interrupt signal indicative of this variation to the CPU 17.

Based on the address information signal and sink interrupt signal that are delivered from the physical address demodulation unit 36, the CPU 17 successively recognizes the recording position on the optical disc 13 at each time, and executes a necessary control process so as to be able to correctly record data on the optical disc 13 on the basis of the recognition result.

On the other hand, at the time of the reproduction mode, the CPU 17 controls the servo control unit 37, thereby rotating the optical disc 13 at a predetermined speed, in the same manner as in the recording mode, moving the beam spot along the data tracks of the optical disc 13 and executing the tracking control and focus control.

In addition, the CPU 17 drives the optical pickup head 30, thereby emitting a light beam to the optical disc 13. As a result, the light beam is reflected by the recording surface of the optical disc 13, and the read data (RF signal), which is read out from the optical disc 13 on the basis of the reflective light, is supply to the decoder unit 50 via the RF amplifier 35.

The decoder unit 50 extracts a clock CLK from the read data. Based on the clock CLK supplied, the decoder unit 50 reads out the data. The decoder unit 50 subjects the read data to a demodulation process and an error correction process. Thereby, the read data is converted to the pre-record data of the original format. Thereafter, the data is sent to the host computer 100 via the buffer memory 12 and interface unit 11.

This apparatus includes a digital circuit block 61 which is driven with a voltage of 3.3V, and an analog circuit block 62 which is driven with a voltage of 5V. The digital circuit block 61 includes, for example, the memory 12, CPU 17, encoder unit 20, physical address demodulation unit 36, servo control unit 37 and decoder unit 50. The analog circuit block 62 includes the optical pickup head 30, RF amplifier 35, actuator driver 38, thread driver 39, spindle driver 40, thread motor 41 and spindle motor 42.

The apparatus also includes a reset circuit 70 for resetting the digital circuit block 61 and the analog circuit block 62. The reset circuit 70 includes a digital reset unit 71 for resetting the digital circuit block 61, and an analog reset unit 72 for resetting the analog circuit block 62. The structures of the digital reset unit 71 and the analog reset unit 72 are implemented by adjusting the values of the resisters R1, R2 and capacitors C1, C2 in the reset unit of the reset circuit shown in FIG. 1.

The reset of the analog circuit block 62 refers to, for example,

(1) power muting ON/OFF control in, e.g. the driver IC including the actuator driver 38, thread driver 39 and spindle driver 40, and

### (2) ON/OFF control of the recording operation in, e.g. the RF amplifier 35.

The reset circuit of the optical disc apparatus is constructed, as described above. Thus, for example, even if the operation of the analog circuit block 62 is temporarily halted due to a decrease in power supply voltage Vcc, the digital circuit block 61 can continuously be operated as long as no fault occurs in the digital circuit block 61, and a needless reset operation can be prevented.

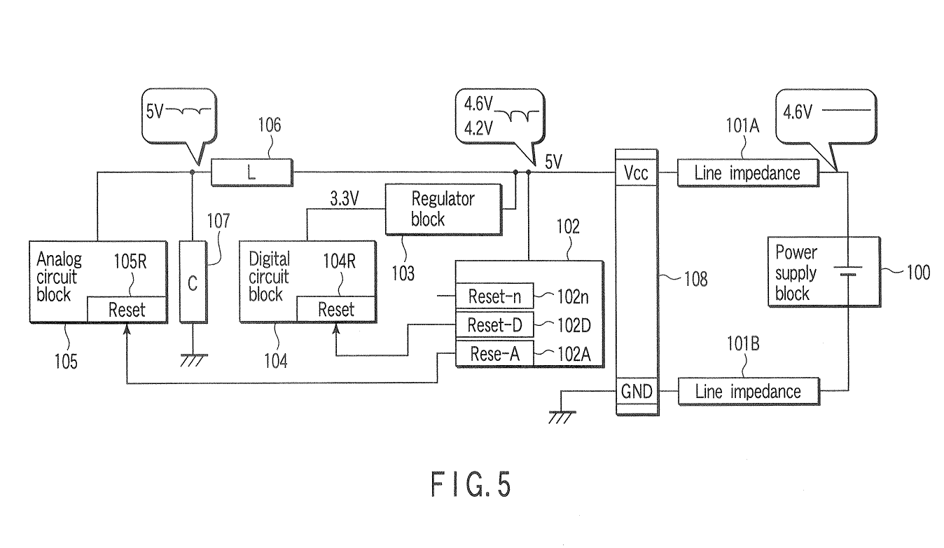

FIG. 5 shows an example in which a plurality of outputs of the reset unit 102 are not wired-OR connected and the reset unit 102 output reset signals which are set at respective DC voltage thresholds and noise frequency responses.

In this case, too, the reset of the analog circuit block 105 refers to, for example,

(1) power muting ON/OFF control in, e.g. the driver IC, and

### (2) ON/OFF control of the recording operation in, e.g. the recording/reproducing RF amplifier 35.

As has been described above, it is possible to prepare, even if there are a plurality of circuit blocks with different operation power supply voltages and power supply noise frequency responses, a plurality of voltage thresholds and frequency responses which are optimal to a reset control of each of the circuit blocks. Thereby, a reset operation, which is unnecessary for the other circuit block, can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An reset control apparatus comprising:
a first circuit block which operates on the basis of a first power supply specification;
a second circuit block which operates on the basis of a second power supply specification that is different form the first power supply specification;
a first reset signal output unit which supplies to the first circuit block a first reset signal for resetting the first circuit block on the basis of a first reset specification;
a second reset signal output unit which supplies to the second circuit block a second reset signal for resetting the second circuit block on the basis of a second reset specification that is different from the first reset specification; and
a power voltage unit which supplies a predetermined voltage to the first reset signal output unit and the second reset signal output unit.

2. An reset control apparatus according to claim 1, wherein the first reset signal output unit includes a first operational amplifier and a first integrating circuit,
the first operational amplifier includes a first input terminal to which a first voltage converted with the predetermined voltage by the first integrating circuit is supplied, and a second input terminal to which a first threshold voltage is supplied, and
the first reset signal output unit supplies to the first circuit block the first reset signal when the first operational amplifier is detected that the voltage value of the first voltage is equal to the voltage value of the first threshold voltage or less.

3. An reset control apparatus according to claim 1, wherein the first reset signal output unit includes a first operational amplifier and a first integrating circuit,
the first operational amplifier includes a first input terminal to which a first voltage converted with the predetermined voltage by the first integrating circuit is supplied, and a second input terminal to which a first threshold voltage is supplied, and
the first reset signal output unit supplies to the first circuit block the first reset signal when the first operational amplifier is detected that a noise frequency that is superimposed on the first voltage is equal to a first frequency or more.

4. An reset control apparatus according to claim 1, wherein the second reset signal output unit includes an second operational amplifier and a second integrating circuit,
the second operational amplifier includes a first input terminal to which a second voltage converted with the predetermined voltage by the second integrating circuit is supplied, and a second input terminal to which a second threshold voltage is supplied, and
the second reset signal output unit supplies to the second circuit block the second reset signal when the second operational amplifier is detected that the voltage value of the second voltage value is equal to the voltage value of the second threshold voltage or less.

5. An reset control apparatus according to claim 1, wherein the second reset signal output unit includes an second operational amplifier and a second integrating circuit,
the second operational amplifier includes a first input terminal to which a second voltage converted with the predetermined voltage by the second integrating circuit is supplied, and a second input terminal to which a second threshold voltage is supplied, and
the second reset signal output unit supplies to the second circuit block the second reset signal when the second operational amplifier is detected that a noise frequency that is superimposed on the second voltage is equal to a second frequency or more.

6. The reset control apparatus according to claim 1, wherein one of the first circuit block and the second circuit block is a digital circuit, and the other is an analog circuit.

7. The reset control apparatus according to claim 1, wherein an output of the first reset signal output unit and an output of the second reset signal output unit are wired-OR connected.

8. An optical disc apparatus comprising:
a digital circuit block which operates on the basis of a first power supply specification and includes at least a CPU;
an analog circuit block which operates on the basis of a second power supply specification and includes at least an optical pickup head;
a first reset signal output unit which supplies to the digital circuit block a first reset signal for resetting the digital circuit block on the basis of a first reset specification; and
a second reset signal output unit which supplies to the analog circuit block a second reset signal for resetting the analog circuit block on the basis of a second reset specification that is different from the first reset specification.
